(19) United States
(12) Patent Application Publication
(10) Pub. No.: US 2013/0277303 A1
(43) Pub. Date: Oct. 24, 2013

(54) SUB-2 MICRON CHIRAL STATIONARY PHASE SEPARATION AGENT

(71) Applicant: OROCHEM TECHNOLOGIES, INC., LOMBARD, IL (US)

(72) Inventors: David W. House, Arlington Heights, IL (US); Asha A. Oroskar, Oak Brook, IL (US)

(73) Assignee: OROCHEM TECHNOLOGIES, INC., LOMBARD, IL (US)

(21) Appl. No.: 13/756,078

(22) Filed: Jan. 31, 2013

Related U.S. Application Data
(62) Division of application No. 13/506,459, filed on Apr. 20, 2012, now abandoned.

(51) Int. Cl. B01J 20/28; B01D 15/26

(52) U.S. Cl. CPC B01J 20/28021; B01D 15/265
USPC 210/635; 210/198.2; 428/402

(57) ABSTRACT

The present invention relates to a porous sub-2 chiral stationary phase agent that provides stability and increased productivity for chiral separation using HPLC and UHPLC methods. It was surprisingly discovered that highly stable and backpressure resistant coated and at least partially covalently bonded chiral stationary phase agents having an average particle diameter less than 2 microns can be obtained by maintaining a pore ratio of from 0.0042 to about 0.010.

### CROSS-REFERENCE TO RELATED APPLICATIONS

The present application is a divisional of U.S. patent application Ser. No. 13/506,459, filed Apr. 20, 2012, now abandoned, which is hereby incorporated by reference.

### FIELD OF THE INVENTION

This invention is generally concerned with improved chiral stationary phase agents used for separating or enriching a broad range of optical isomer pairs by liquid chromatography. More particularly, the instant invention relates to a polysaccharide-based family of sub-2 micron stationary phase agents for the very rapid separation of racemates which are separable on 3 micron and larger analogs. Combining the chiral stationary phase agents with ultra high performance liquid chromatography (UHPLC) provides faster separations, higher throughput (i.e., more sample analyses per hour), higher efficiency columns, and lower solvent costs.

### BACKGROUND OF THE INVENTION

The present invention relates to chiral column chromatography and chiral stationary phase agents. Chiral column chromatography is a method of separation or analysis based on conventional chromatography. In chiral column chromatography a column is packed with an adsorbent or stationary phase agent wherein the stationary phase agent typically contains a single enantiomer of a chiral compound forming a single enantiomer stationary phase. In order to separate the enantiomers of an analyte comprising two enantiomers which differ in their affinity for the single enantiomer of the chiral stationary phase agent, the analyte is passed through the chiral column. The two enantiomers of the same analyte exit the chiral column containing the chiral stationary phase agent at different times and are thus separated.

U.S. Pat. No. 5,811,532 discloses preparation methods of chiral stationary phase agents for particle sizes greater than sub-2 microns. Chiral stationary phase agents can be prepared by attaching a suitable chiral compound to the surface of a support material or porous granular carrier to create the chiral stationary phase agent. The particle size of the porous granular carrier generally determines the particle size of the chiral stationary phase agent. Particle sizes ranging from 1 micron to 10 mm, and more typically 1 to 300 microns have been disclosed. The porous granular carrier is generally a porous material having a pore size, which generally represents the average pore diameter of the pores within each particle. Pore sizes of from 10 Angstroms to 100 microns and from 50 to 50,000 Angstroms are disclosed in the art. The porous granular carriers are typically refractory inorganic oxides which generally have a surface area of at least about 35 m²/g, preferably greater than about 50 m²/g, and more desirably greater than 100 m²/g. Disclosed are such suitable refractory inorganic oxides including alumina, titania, zirconia, chromia, silica, boria, silica-alumina, and combinations thereof. Of these silica is particularly preferred.

In chiral stationary phase agents, the refractory inorganic oxide has bound surface hydroxyl groups, by which is meant that these bound surface hydroxyl groups are not adsorbed water, but are hydroxyl (OH) groups whose oxygen is bound to the metal of the inorganic oxide. These latter hydroxyl groups sometimes have been referred to as chemically combined hydroxyl. Because the presence of merely adsorbed water is generally detrimental to the preparation of the chiral stationary phases, typically, the refractory inorganic oxides are first treated to remove surface hydroxyl groups arising from water. Usually, removal of water is accomplished by heating the refractory inorganic oxide to a temperature which specifically and preferentially removes physically adsorbed water without chemically altering the other hydroxyl groups. When the inorganic oxide is silica, for example, heating to temperatures up to about 120° C. are usually satisfactory. For alumina, heating to temperatures in the range 125-700° C. have proved adequate, and it is preferred to heat to temperatures of 125-250° C. As an alternative to heat treatment, silica gel may be activated by azeotropically removing the adsorbed water using benzene, toluene, or another solvent forming an azeotrope with water.

Typically, chiral compounds are attached to the support particles or carriers by either a coating process, or a covalent bonding process. Suitable chiral compounds which are attached to the support particles include chiral polysaccharides or derivatized polysaccharides to provide the chiral stationary phase particles. Examples of chiral stationary phase particles prepared by coating methods are disclosed in U.S. Pat. No. 4,818,394. In U.S. Pat. No. 4,818,394, it is disclosed and claimed that the carriers onto which the polysaccharide-based systems are coated or bonded have a ratio of particle pore size to the diameter of the particle that is not larger than 0.1:1. U.S. Pat. No. 5,811,532, which is hereby incorporated by reference, discloses a method of preparing and a structure of polysaccharide-based chiral stationary phases where the chiral stationary phase is covalently bound to a carrier more directly and with fewer requisite process steps than disclosed in U.S. Pat. No. 4,619,970. As disclosed in U.S. Pat. No. 5,811,532, the stable, non-leaching chiral stationary phase embodies a carrier which is covalently bonded to one terminus of an isocyanato alkylene siloxane as a spacer whose other terminus is covalently bonded to a chiral polysaccharide or derivatized polysaccharide. The preferred refractory inorganic oxide carriers are alumina and silica gel. Cellulose esters and cellulose phenyl carbamates are among the most favored polysaccharides.

The chiral stationary phase agents are packed in narrow columns to prepare a chiral high pressure liquid chromatography column (HPLC) or an ultra-high pressure liquid chromatography column (UHPLC). The basic methods of separation in HPLC rely on a mobile phase (water, organic solvents, etc., and suitable blends of the two) which is passed through a stationary phase agent in a closed environment (column). The differences in interaction among the compounds to be separated, the mobile phase and the stationary phase agent distinguish the compounds from one another in a series of adsorption and desorption phenomena.

As industry focus shifts to biotechnology, the demand for better resolution is raising interest and demand for smaller and smaller particle sizes. Smaller particle sizes generally translate to better resolution and shorter run times providing an increase in efficiency and productivity. However, associated with moving to smaller particles such as 3 micron (μm), and less, are significant and steep increases in backpressure in the chiral stationary phase column. Typically, HPLC columns have an upper limit of less than 400 bar. In order to accommodate the demand for the increase in pressure, the ultra-high, or UHPLC columns were introduced which were able to endure pressures of up to 1,000 bar.

To decrease run times and increase selectivity, smaller diffusion distances were required. One way to achieve small diffusion distances has been to decrease the particle sizes. However, as the particle size is decreased, the backpressure increases. The backpressure, or the pressure required to operate the HPLC column filled with the stationary phase agent is inversely proportional to the square of the particle size. Thus, when particle size is halved, backpressure increases by a factor of four. The backpressure increase occurs because as the particle sizes get smaller, the interstitial voids (the spaces between the particles) are reduced in size as well. The increased difficulty in pushing compounds through the smaller spaces results in the increased backpressure.

Chiral stationary phase materials are well-known for their broad applicability in separation of optical isomers and are generally available in various particle sizes ranging from 1.7 to 20 microns (μm). Typically, chiral stationary phase agents prepared by coating particles with polysaccharides typically employ pore sizes of at least 1000 Angstroms to assure that the substrate remains porous during and after the coating process such that chiral polysaccharide coatings or bound materials do not block the pores of the chiral stationary phase agents. However, as particle size is reduced in an attempt to attain increased efficiencies, the chiral stationary phase becomes more fragile and unstable. This instability often leads to premature failure and collapse or crushing of the chiral stationary phase in the chromatographic column under pressure.

More structurally stable chiral stationary phase materials are sought for the separation or enrichment of optical isomer pairs primarily by liquid chromatographic methods including UHPLC, HPLC, SFC (supercritical fluid chromatography), and SMB (simulated moving bed chromatography).

Chiral stationary phase materials are sought which provide improved stability to permit the separation of optical isomers with sub-2 micron (μm) chiral stationary phases with increased productivity and efficiency.

### SUMMARY OF THE INVENTION

The present invention relates to sub-2 micron chiral stationary phase agents that provide stability and increased productivity for chiral separation using HPLC and UHPLC methods. It was surprisingly discovered that highly stable and backpressure resistant coated and covalently bonded chiral stationary phase agents having an average particle diameter less than about 2 microns and a pore size range of between about 90 and about 150 Angstroms, can be obtained by maintaining a pore size/particle size ratio of from 0.0045 to about 0.010 for a particle size of from about 1.5 to 1.9 microns.

In one embodiment, the invention is a chiral stationary phase agent having a particle size less than about 2 microns in diameter. The chiral stationary phase comprises a porous granular carrier and a polysaccharide or derivatized polysaccharide. The porous granular carrier is porous, has a particle size of from 1.5 to 1.9 microns, and has an average pore size of from about 50 Angstroms to about 200 Angstroms and wherein the porous granular carrier has a ratio of pore size/particle size ranging from about 0.0045 to about 0.010. The porous granular carrier is coated with the polysaccharide or derivatized polysaccharide which is selected from the group consisting of cellulose tris-(3-chloro-4-methylphenylcarbamate), amylose tris-(3,5-dimethylphenylcarbamate), amylose tris-(3-chloro-4-methylphenylcarbamate), cellulose tris-(4-methylbenzoate), amylose tris-(4-methylbenzoate), amylose tris-(4-chloro-3-methylphenylcarbamate), amylose tris-(5-chloro-2-methylphenylcarbamate), cellulose tris-(4-chloro-3-methylphenylcarbamate), and cellulose tris-(5-chloro-2-methylphenylcarbamate). The porous granular carrier is selected from the group consisting of alumina, magnesia, titanium oxide, glass, silica, and kaolin.

In another embodiment, the invention is a chiral stationary phase agent having a particle size less than about 2 microns in diameter. The chiral stationary phase comprises a porous granular carrier and a polysaccharide or derivatized polysaccharide, wherein the porous granular carrier is porous having an average pore size of from about 50 Angstroms to about 200 Angstroms and a ratio of pore size/particle size from about 0.0045 to about 0.010. The porous granular carrier is covalently bonded to the polysaccharide or derivatized polysaccharide. The polysaccharide or derivatized polysaccharide is selected from the group consisting of cellulose tris-(3,5-methylphenylcarbamate), cellulose tris-(3-chloro-4-methylphenylcarbamate), amylose tris-(3,5-dimethylphenylcarbamate), amylose tris-(3-chloro-4-methylphenylcarbamate), cellulose tris-(4-methylbenzoate), amylose tris-(4-methylbenzoate), amylose tris-(4-chloro-3-methylphenylcarbamate), amylose tris-(5-chloro-2-methylphenylcarbamate), cellulose tris-(4-chloro-3-methylphenylcarbamate), and cellulose tris-(5-chloro-2-methylphenylcarbamate). The porous granular carrier is selected from the group consisting of silica, alumina, magnesia, titanium oxide, glass, silicate, and kaolin.

### DETAILED DESCRIPTION OF THE INVENTION

Liquid chromatographic stationary phases containing sub-2 micron particles exhibit much higher column efficiencies than columns packed with larger particle sizes. This greater efficiency permits the use of columns with much smaller volumes, which dramatically decreases the turnaround time for each analysis. The amount of mobile phase needed to elute the samples from the column is also significantly less. Such columns are ideal for analyzing a large number of samples in much less time than their larger particle-larger column volume counterparts. A time savings of 90% is not uncommon. These small, efficient columns are also beneficial for hyphenated analyses, such as LC-MS, where it is necessary to minimize the amount of solvent present. Inline analyses also benefit from the smaller, more efficient columns.

The porous sub-2 micron particles do demonstrate much higher backpressures than their larger particle size counterparts. By porous sub-2 micron particles, it is meant that the average particle diameter of the uniformly porous particles which are coated or covalently bound is between about 0.5 and 1.9 microns. Furthermore, by the term porous sub-2 micron particle, it is meant that the particle has a particle diameter less than or equal to 2 microns and is uniformly porous. In order to maintain column performance at higher backpressures and reasonable flow rates, the columns themselves must be packed at higher pressures. The ratio of pore size/particle size becomes critical for such particles. If the pore size is too large, then the particle matrix may be too fragile and may crush under the packing pressure or even the backpressure used to run the column on the liquid chromatographic device. It is believed that it is critical that the instant invention avoids such particle crushing by using sub-2 micron particles that have pore sizes of 200 microns and less, and it is especially critical that the sub-2 micron particle (nominally a particle diameter between about 1.5 and 1.9 microns) have a pore size/particle size ratio of between 0.0047 to 0.0133, or more preferably, that the sub-2 micron particle having a particle diameter of about 1.7 microns have a pore size/particle size ratio of between about 0.006 to about 0.010 and have a pore size between about 90 Angstroms and about 150 Angstroms. Most preferably, it is critical that the sub-2 micron particles having a particle diameter of about 1.7 microns have a pore size/particle size ratio of between about 0.006 and about 0.008 have a pore size between about 100 Angstroms and about 120 Angstroms.

The reason that a larger pore size is typically used with polysaccharide-based chiral stationary phase agents is that the larger pore size (typically 1000 Angstroms) allows one to load a higher level of assessable chiral material onto the particles of the support material. This increased loading of chiral material provides an increased number of assessable chiral sites and thereby increases the separation value one can obtain from the chiral stationary phase agent. However, as the stationary phase particle size decreases and the void of the pore size of the particle remains constant, the material remaining in the struts between the pores within the stationary phase particles which function to hold the stationary phase particle together decreases. As a result, the crush strength of the particle is decreased. For particle sizes under about 3 microns with pore sizes of about 1000 Angstroms, the decrease in crush strength is such that the particles cannot withstand the pressure required to pack the column or to run the packed column at a reasonable flow rate on an HPLC without the failure of the column. Thus, in terms of the ratio of pore size/particle size, for conventional chiral stationary phase agents, as the size of the particle was reduced, the ratio of pore size/particle size was actually increasing. For example, a 5 micron particle with a 1000 Angstrom average pore size has a ratio of pore size/particle size of about 0.02. For a 3 micron particle with a 1000 Angstrom average pore size the ratio of pore size/particle size has increased to about 0.03. Applicant discovered that only by reducing the ratio of pore size/particle size when the particle size is reduced, can the stability and efficiency of the chiral stationary phase agent be maintained or improved.

Generally the polysaccharide or derivatized polysaccharide chiral material has the carbamate structure of formula (I) or the benzoyl structure of formula (II):

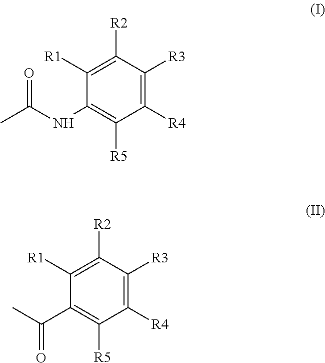

where at least one of R1 to R5 is either hydrogen or a straight chain alkyl having from 1 to 12 carbon atoms, or a branched alkyl having 3 to 12 carbon atoms, or halogen. Examples of alkyl-phenylcarbamate derivatives representing some of such derivatized polysaccharides are disclosed in U.S. Pat. No. 4,861,872, and are hereby incorporated by reference. Examples of derivatized polysaccharides based on benzoyls structures as cellulose derivatives selected from the group consisting of cellulose tribenzoate and cellulose tribenzoate ring-substituted with alkyl, alkenyl, alkynyl, nitro, halogen, amino, alkyl-substituted amino, cyano, hydroxyl, alkoxy, acyl, thiol, sulfonyl, carboxyl or alkoxy carbonyl are disclosed in U.S. Pat. RE 38,435, and are hereby incorporated by reference. Preferred polysaccharide or derivatized polysaccharides include cellulose tris-(3,5-dimethylphenylcarbamate), cellulose tris-(3-chloro-4-methylphenylcarbamate), amylose tris-(3,5-dimethylphenylcarbamate), amylose tris-(3-chloro-4-methylphenylcarbamate), cellulose tris-(4-methylbenzoate), amylose tris-(4-methylbenzoate), amylose tris-(4-chloro-3-methylphenylcarbamate), amylose tris-(5-chloro-2-methylphenylcarbamate), cellulose tris-(4-chloro-3-methylphenylcarbamate), or cellulose tris-(5-chloro-2-methylphenylcarbamate). More preferably, polysaccharide or derivatized polysaccharides include amylose tris-(3,5-dimethylphenylcarbamate), amylose tris-(3-chloro-4-methylphenylcarbamate), cellulose tris-(3,5-dimethylphenylcarbamate), cellulose tris-(3-chloro-4-methylphenylcarbamate), or cellulose tris-(4-methylbenzoate).

Conventional chiral stationary phase agents based on polysaccharides typically have pore sizes of about 1000 Angstroms and have associated particle sizes greater than or equal to about 3 μm.

The following examples are merely exemplary of the invention and are not intended to limit it in any way. Variants will be readily appreciated by the skilled artisan, and it is intended that these variants be subsumed within the invention as claimed.

### EXAMPLES

### Example 1

Table 1 below illustrates the benefits of the 1.7 micron chiral stationary phase agents of the instant invention over more conventional 5 micron counterparts for both coated (EPITOMIZE CSP-1A) and covalently-bonded (EPITOMIZE CSP-2A) phases. (EPITOMIZE CSP-1A and EPITOMIZE CSP-2A are available from Orochem Technologies Inc., Lombard, Ill.) Both the CSP-1A and CSP-2A chiral stationary phases are based on amylose tris-(3,5-dimethylphenylcarbamate). The pore size of the 1.7 micron phases was 120 Angstroms and the pore size of the 5 micron phases was 1000 Angstroms. All the stationary phases were packed into UHPLC columns with dimensions of 3.0 mm I.D. by 50 mm long. The mobile phase was 10% 2-propanol in heptane and the flow rate was 0.20 mL/min. The analyte was trans-stilbene oxide. The number of theoretical plates per meter, or TP/m, is a representation of column efficiency and was based on the second optical isomer peak. The column temperature was 20° C. in all cases. The pore size/particle size ratio is shown as “Pore/Part. Ratio”. Using the 1.7 micron particles increased the column efficiency (TP/m) by around 30% for both the coated and the covalently-bound CSPs accompanied by a 6 (CSP-2A) to 10 (CSP-1A) fold increase in the backpressure required for the same flow rate of the sample through the columns.

TABLE 1
Comparison of the 1.7 micron CSPs to their 5 micron
counterparts.

| | CSP-1A* | | CSP-2A* | |
|---|---|---|---|---|
| | 1.7 Micron | 5 Micron | 1.7 Micron | 5 Micron |
| Pore Size, | 120 | 1000 | 120 | 1000 |
| Angstroms | | | | |
| Sep. Value | 2.36 | 2.49 | 1.43 | 1.45 |
| TP/m | 98,900 | 76,300 | 115,700 | 88,600 |
| Backpressure, | 993 (68.5) | 96 (6.6) | 500 (34.5) | 87 (6.0) |
| psi (bar) | | | | |
| Pore/Part. | 0.0071 | 0.0200 | 0.0071 | 0.0200 |
| Ratio | | | | |

### Example 2

Examples of chiral separations effected using the following chiral stationary phase agents available from Orochem Technologies Inc.:

EPITOMIZE CSP-1C, a cellulose tris-(3,5-dimethylphenylcarbamate) coated silica gel particle,

EPITOMIZE CSP-1A, an amylose tris-(3,5-dimethylphenylcarbamate) coated silica gel particle,

EPITOMIZE CSP-1K, an amylose tris-(3-chloro-4-methylphenylcarbamate) coated silica gel particle, and

EPITOMIZE CSP-1Z, a cellulose tris-(3-chloro-4-methylphenylcarbamate) coated silica gel particle. All chiral stationary phase agents had a particle diameter of 1.7 microns and a pore diameter of 120 Angstroms. The 1.7 micron chiral stationary phase agents were slurry packed into stainless steel UHPLC columns measuring 2.1 mm I.D. by 50 mm long. The flow rate of the mobile phase was 0.15 mL/min and the column temperature was 25° C. in all cases. The effluent was monitored using a UV detector set a wavelength of 254 nm. Table 2, shown hereinbelow, illustrates the performance of the 1.7 micron chiral stationary phase agents using several different racemates.

TABLE 2
Examples of chiral separations using Coated 1.7 micron chiral
stationary phase agents.

| | | | | | Sep. |
|---|---|---|---|---|---|
| Column | Racemate | Mobile Phase | k₁ | k₂ | Value |
| 1C (1) | Benzoin | 90/10 Heptane/IPA | 4.32 | 5.50 | 1.27 |
| 1C | 1-Phenoxy-2- | 90/10 Heptane/IPA | 2.26 | 4.17 | 1.84 |
| | propanol | | | | |
| 1C | Propranolol | 80/20/0.1 | 2.22 | 3.39 | 1.53 |
| | | Heptane/IPA/ | | | |
| | | ethanolamine | | | |
| 1C | Pindolol | 100/0.1 | 2.37 | 2.91 | 1.23 |
| | | Acetonitrile/ | | | |
| | | ethanolamine | | | |
| 1C | trans-Stilbene oxide | 90/10 Heptane/IPA | 0.41 | 0.72 | 1.78 |
| 1A (2) | Troger's Base | 90/10 Heptane/IPA | 0.74 | 0.97 | 1.32 |
| 1A | trans-Stilbene oxide | 90/10 Heptane/IPA | 0.59 | 1.28 | 2.19 |
| 1A | Mianserin | 90/10/0.1 | 0.78 | 1.12 | 1.42 |
| | | Heptane/IPA/ | | | |
| | | diethylamine | | | |
| 1A | Flavanone | Methanol | 0.86 | 1.81 | 2.11 |
| 1K (3) | trans-Stilbene oxide | 90/10 Heptane/IPA | 0.53 | 0.68 | 1.28 |
| 1Z (4) | trans-Stilbene oxide | 90/10 Heptane/IPA | 0.35 | 0.72 | 2.07 |

(1) 1C is based on cellulose tris-(3,5-dimethylphenylcarbamate)
(2) 1A is based on amylose tris-(3,5-dimethylphenylcarbamate)
(3) 1K is based on amylose tris-(3-chloro-4-methylphenylcarbamate)
(4) 1Z is based on cellulose tris-(3-chloro-4-methylphenylcarbamate)

### Example 3

### CSP-1C Based on Silica Gel with an Average Pore Size of 100 Angstroms

EPITOMIZE CSP-1C is a chiral stationary phase agent based on cellulose tris-(3,5-dimethylphenyl-carbamate) having an average pore size of 100 Angstroms (Available from Orochem Technologies Inc., Lombard, Ill.). The product was packed into a 3.0 mm I.D. by 50 mm long UHPLC column according to the procedure outlined in Example 2. The mobile phase used was 90/10 heptane/IPA and the flow rate was 0.20 mL/min. The column temperature was 20° C. The effluent was monitored using a UV detector set at a wavelength of 254 nm. A summary of the results is shown in Table 3 below.

TABLE 3
The separation of trans-stilbene oxide using the EPITOMIZE
CSP-1C chiral separation agent of Example 3.

| | CSP-1C |
|---|---|
| Pore Size, Angstroms | 100 |
| k₁ | 0.98 |
| k₂ | 1.83 |
| Sep. Value | 1.87 |
| TP/m | 115,400 |
| Backpressure, psi (bar) | 930 (64.1) |
| Pore/Part. Ratio | 0.0059 |

Covalently Bound Chiral Stationary Phase Agents

The following examples illustrate the performance of the covalently bound 1.7 micron chiral stationary phase agents of the invention.

### Example 4

Examples of chiral separations effected using the following covalently bonded chiral stationary phase agents (Available from Orochem Technologies Inc., Lombard, Ill.):

EPITOMIZE CSP-2A, an amylose tris-(3,5-dimethylphenylcarbamate) covalently bonded silica gel particle;

EPITOMIZE CSP-2C, an cellulose tris-(3,5-dimethylphenylcarbamate) covalently bonded silica gel particle;

EPITOMIZE CSP-2K, an cellulose tris-(3-chloro-4-methylphenylcarbamate) covalently bonded silica gel particle; and

EPITOMIZE CSP-2Z, a cellulose tris-(3-chloro-4-methylphenylcarbamate) covalently bonded silica gel particle. All of the above covalently bonded chiral stationary phase agents had a particle diameter of 1.7 microns and a pore diameter of 120 Angstroms. The chiral stationary phase agents were slurry packed into stainless steel ultra high performance liquid chromatography (UHPLC) columns 2.1 mm I.D. by 50 mm long using typical slurry packing methods.

Table 4, shown hereinbelow, illustrates the performance of the covalently-bound 1.7 micron chiral stationary phase agents. The flow rate is expressed as mL/min and the column temperature was 25° C. in all cases.

TABLE 4
Examples of chiral separations using 1.7 micron covalently
bonded chiral stationary phase agents.

| | | | | | | Sep. |
|---|---|---|---|---|---|---|
| Column | Racemate | Mobile Phase | Flow | k₁ | k₂ | Value |
| 2A (1) | trans-Stilbene | 90/10 Heptane/ | 0.15 | 0.38 | 0.54 | 1.43 |
| | oxide | IPA | | | | |
| 2C (2) | trans-Stilbene | 90/10 Heptane/ | 0.10 | 0.42 | 0.64 | 1.51 |
| | oxide | IPA | | | | |
| 2C | Warfarin | 50/50/0.1 | 0.15 | 22.61 | 27.20 | 1.20 |
| | | Heptane/CHCl3/ | | | | |
| | | acetic acid | | | | |

(1). 2A is based on amylose tris-(3,5-dimethylphenylcarbamate)
(2). 2C is based on cellulose tris-(3,5-dimethylphenylcarbamate)
3. 2K is based on amylose tris-(3-chloro-4-methylphenylcarbamate)
4. 2Z is based on cellulose tris-(3-chloro-4-methylphenylcarbamate)

Other embodiments are set forth within the following claims.

We claim:

1. A covalently bonded chiral stationary phase agent having a particle size less than about 2 microns in diameter, said chiral stationary phase comprising a porous granular carrier and a polysaccharide or derivatized polysaccharide, wherein said porous granular carrier is porous having a particle size between about 1.5 and about 1.9 microns and having an average pore size of from about 50 Angstroms to about 200 Angstroms and that said porous granular carrier has a ratio of pore size/particle size from about 0.0026 to about 0.0133, wherein the porous granular carrier is covalently bonded to the polysaccharide or derivatized polysaccharide, and wherein the polysaccharide or derivatized polysaccharide is selected from the group consisting of cellulose tris-(3,5-methylphenylcarbamate), cellulose tris-(3-chloro-4-methylphenylcarbamate), amylose tris-(3,5-dimethylphenylcarbamate), amylose tris-(3-chloro-4-methylphenylcarbamate), cellulose tris-(4-methylbenzoate), amylose tris-(4-methylbenzoate), amylose tris-(4-chloro-3-methylphenylcarbamate), amylose tris-(5-chloro-2-methylphenylcarbamate), cellulose tris-(4-chloro-3-methylphenylcarbamate), and cellulose tris-(5-chloro-2-methylphenylcarbamate), and wherein the porous granular carrier is selected from the group consisting of silica, alumina, magnesia, titanium oxide, glass, silicate, and kaolin.

2. The covalently bonded chiral stationary phase agent of claim 1, wherein the porous granular carrier has an average pore size of from about 50 Angstroms to about 120 Angstroms and that said porous granular carrier has a ratio of pore size/particle size from about 0.0026 to about 0.0080.

3. The covalently bonded chiral stationary phase agent of claim 1, wherein the porous granular carrier has an average pore size of from about 90 Angstroms to about 120 Angstroms and that said porous granular carrier has a ratio of pore size/particle size from about 0.0026 to about 0.0080.

4. The covalently bonded chiral stationary phase agent of claim 1, wherein the particle size of the porous granular carrier is about 1.7 microns in diameter and the pore size ranges from about 90 Angstroms to about 120 Angstroms.

5. A chromatographic column comprising the chiral stationary phase agent of claim 1.

6. The covalently bonded chiral stationary phase agent of claim 1, wherein the porous granular carrier is silica gel or alumina.

7. The covalently bonded chiral stationary phase agent of claim 1, wherein the polysaccharide or derivatized polysaccharide is selected from the group consisting of cellulose tris-(3,5-methylphenylcarbamate), amylose tris-(3,5-dimethylphenylcarbamate), cellulose tris-(3-chloro-4-methylphenylcarbamate), and amylose tris-(3-chloro-4-methylphenylcarbamate), and wherein the porous granular carrier is silica or alumina.

8. The covalently bonded chiral stationary phase agent of claim 1, wherein the polysaccharide or derivatized polysaccharide is selected from the group consisting of cellulose tris-(3,5-methylphenylcarbamate) and amylose tris-(3,5-dimethylphenylcarbamate), and wherein the porous granular carrier is silica or alumina.

9. The covalently bonded chiral stationary phase agent of claim 1, wherein the polysaccharide or derivatized polysaccharide is selected from the group consisting of cellulose tris-(3-chloro-4-methylphenylcarbamate) and amylose tris-(3-chloro-4-methylphenylcarbamate), and wherein the porous granular carrier is silica or alumina.

10. The covalently bonded chiral stationary phase agent of claim 1, wherein the polysaccharide or derivatized polysaccharide comprises amylose tris-(3-chloro-4-methylphenylcarbamate), and wherein the porous granular carrier is silica or alumina.

11. The covalently bonded chiral stationary phase agent of claim 1, wherein the polysaccharide or derivatized polysaccharide comprises cellulose tris-(3,5-methylphenylcarbamate), and wherein the porous granular carrier is silica or alumina.

12. The covalently bonded chiral stationary phase agent of claim 1, wherein the polysaccharide or derivatized polysaccharide comprises amylose tris-(3,5-dimethylphenylcarbamate), and wherein the porous granular carrier is silica or alumina.

13. The covalently bonded chiral stationary phase agent of claim 1, wherein the polysaccharide or derivatized polysaccharide is selected from the group consisting of cellulose tris-(4-methylbenzoate) and amylose tris-(4-methylbenzoate), and wherein the porous granular carrier is silica or alumina.

14. A process for the separation or enrichment of optical isomer pairs by liquid chromatographic methods said process comprising passing said isomer pairs at effective chromatographic conditions for chiral separation of enantiomers of an analyte to a chromatographic column comprising the covalently bonded chiral stationary phase agent of claim 1.
